(19) United States
(12) Patent Application Publication
(10) Pub. No.: US 2011/0205199 A1
(43) Pub. Date: Aug. 25, 2011

(54) DISPLAY APPARATUS AND TELEVISION RECEIVING APPARATUS

(75) Inventor: Kohji Hisakawa, Osaka (JP)

(73) Assignee: SHARP KABUSHIKI KAISHA, Osaka (JP)

(21) Appl. No.: 13/126,997

(22) PCT Filed: Aug. 27, 2009
(86) PCT No.: PCT/JP2009/064913

§ 371 Date: Apr. 29, 2011

(30) Foreign Application Priority Data
Nov. 11, 2008 (JP) 2008-288692

(51) Int. Cl. G09G 3/36; G06F 3/038

(52) U.S. Cl. 345/205; 345/87

(57) ABSTRACT

Provided is a display apparatus including a display panel (11), control substrates (20) disposed along the periphery of the display panel (11) to control the display of the display panel (11), flexible substrates (21) that electrically and mechanically connect the display panel (11) and the control substrates (20) together, and reinforcing members (25) that mechanically connect the display panel (11) and the control substrates (20) together. The thickness of connecting portions (25A) of the reinforcing member (25) for connection to the display panel (11) and to the control substrate (20) is equal to or smaller than the thickness of connecting portions (21A) of the flexible substrate (21) for connection to the display panel (11) and to the control substrate (20). The connecting portions (21A) of the flexible substrate (21) and the connecting portions (25A) of the reinforcing member (25) are bonded to the display panel (11) and to the control substrate (20) by anisotropic conductive films (24).

### TECHNICAL FIELD

The present invention relates to a display apparatus that displays images and a television receiving apparatus.

### BACKGROUND ART

Display apparatuses such as those disclosed in Patent Document 1 are conventionally known. Such display apparatuses have a display panel that displays images, and control substrates that control the driving of the display panel. The control substrates are provided along the periphery of the display panel, and are connected to the display panel through flexible substrates. The flexible substrates are films having electrically-conducting paths printed thereon and a driver mounted thereon. One end of the flexible substrate is connected to a terminal section of the display panel, and the other end is connected to a terminal section of the control substrate. The control substrate is fixed to a frame holding the display panel.

Patent Document 1: Japanese Patent Application Laid-Open Publication No. 2007-226068

### PROBLEMS TO BE SOLVED BY THE INVENTION

The coefficient of thermal expansion of the glass substrate constituting a display panel is very different from that of a frame holding the display panel. As a result, when the control substrates are fixed to the frame as described above, the flexible substrates are subjected to a stress by being pulled or because of other reasons. This causes problems such as breakage in the electrically-conducting paths laid out on the flexible substrate or detachment of the flexible substrate from the display panel or the control substrate, which could deteriorate the display quality of the display apparatus.

Even if the control substrate is not fixed to the frame, the flexible substrate would directly receive the weight of the control substrate and/or experience a stress by being subjected to the vibration of the control substrate or the like, which could still result in a lower display quality.

### SUMMARY OF THE INVENTION

The present invention was devised in consideration of the situation described above, and is aiming at providing a display apparatus and television receiving apparatus that can prevent the deterioration of the display quality.

### MEANS FOR SOLVING THE PROBLEMS

A display apparatus of the present invention includes a display panel, control substrates disposed along a periphery of the display panel to control display of the display panel, flexible substrates interposed between the display panel and the control substrate to electrically and mechanically connect them together, and reinforcing members interposed between the display panel and the control substrate to mechanically connect them together, wherein the thickness of connecting portions of the reinforcing member, which are for connection to the display panel and to the control substrate, is equal to or smaller than the thickness of connecting portions of the flexible substrate, which are for connection to the display panel and to the control substrate; and the connecting portions of the flexible substrate and the connecting portions of the reinforcing member are bonded to the display panel and to the control substrate by anisotropic conductive films.

With such configuration, the display panel and the control substrate are mechanically connected together not only by the flexible substrates but also by the reinforcing members. As a result, the force generated by vibration of the control substrate or the like is received not only by the flexible substrates but also by the reinforcing members. This structure reduces the stress placed on the flexible substrates compared to the case where the display panel and the control substrate are connected together by the flexible substrates alone, thereby preventing the deterioration of the display quality. Also, the flexible substrates and the reinforcing members can be bonded to the display panel and to the control substrates simultaneously, which makes the bonding process simpler compared to the case where these components are bonded separately.

The flexible substrate is composed of a film with an electronic component mounted thereon, and the reinforcing member may be composed only of the film of the flexible substrate. This configuration ensures that the thickness of the connecting portions of the reinforcing member is equal to the thickness of the connecting portions of the flexible substrate, and therefore, careful attention is not required to set the thicknesses.

A strengthening member may be attached to the reinforcing member. According to this configuration, the reinforcing member can have a greater rigidity and consequently can handle more force from vibration of the control substrate or the like, which reduces the stress placed on the flexible substrate.

The strengthening member may be attached to at least one of the front and back sides of the reinforcing member.

The strengthening member may be sheet-shaped.

The thickness of the strengthening member may be greater than the thickness of the reinforcing member. This configuration significantly improves the rigidity of the reinforcing member, thereby further reducing the stress placed on the flexible substrate.

The strengthening member may be attached to the entirety of at least one of the front and back sides of the reinforcing member. This configuration improves the rigidity of the reinforcing member as a whole.

The strengthening member may be a polyimide film.

The portion of the reinforcing member that is not connecting portions for connection to the display panel and the control substrate may have a greater thickness than the connecting portions. With this configuration, the reinforcing member and the flexible substrate can be bonded simultaneously, and the reinforcing member can have a great rigidity.

The reinforcing member may be connected to the ends of a longer side of the control substrate. Here, the ends of the control substrate are locations that are most likely to be subjected to the forces from vibration of the control substrate or the like, and connecting the reinforcing members to such locations further reduces the stress placed on the flexible substrate.

The display panel may be a liquid crystal panel utilizing liquid crystals.

A television receiving apparatus of the present invention includes the display apparatus.

### EFFECTS OF THE INVENTION

According to the present invention, a display apparatus and a television receiving apparatus that can prevent display quality deterioration can be provided.

### BRIEF DESCRIPTION OF THE DRAWINGS

FIG. 1 is a schematic exploded perspective view of a television receiving apparatus according to Embodiment 1.

FIG. 2 is a schematic exploded perspective view of a liquid crystal display apparatus.

FIG. 3 is a cross sectional view of a liquid crystal display apparatus.

FIG. 4 is an enlarged plan view of an array substrate of a liquid crystal panel.

FIG. 5 is a plan view that shows a liquid crystal panel as connected to a driver substrate through flexible substrates and reinforcing films.

FIG. 6 is a partial enlarged view of a flexible substrate as connected to a liquid crystal panel and a driver substrate.

FIG. 7 is a partial enlarged cross sectional view of a reinforcing film as connected to a liquid crystal panel and a driver substrate.

FIG. 8 is a partial enlarged cross sectional view of a reinforcing film according to Embodiment 2 as connected to a liquid crystal panel and a driver substrate.

FIG. 9 is a partial enlarged cross sectional view of a reinforcing film according to Embodiment 3 as connected to a liquid crystal panel and a driver substrate.

### DESCRIPTION OF REFERENCE CHARACTERS

TV television receiving apparatus
10 liquid crystal display apparatus (display apparatus)
11 liquid crystal panel (display panel)
20 driver substrate (control substrate)
21 flexible substrate
21A flexible substrate connecting portion
22 film
23 driver (electronic component)
24 anisotropic conductive film
25, 60 reinforcing film (reinforcing member)
25A, 60A reinforcing member connecting portion
50 strengthening film (strengthening member)
60B main portion (reinforcing member minus the connecting portion)

### DETAILED DESCRIPTION OF EMBODIMENTS

### Embodiment 1

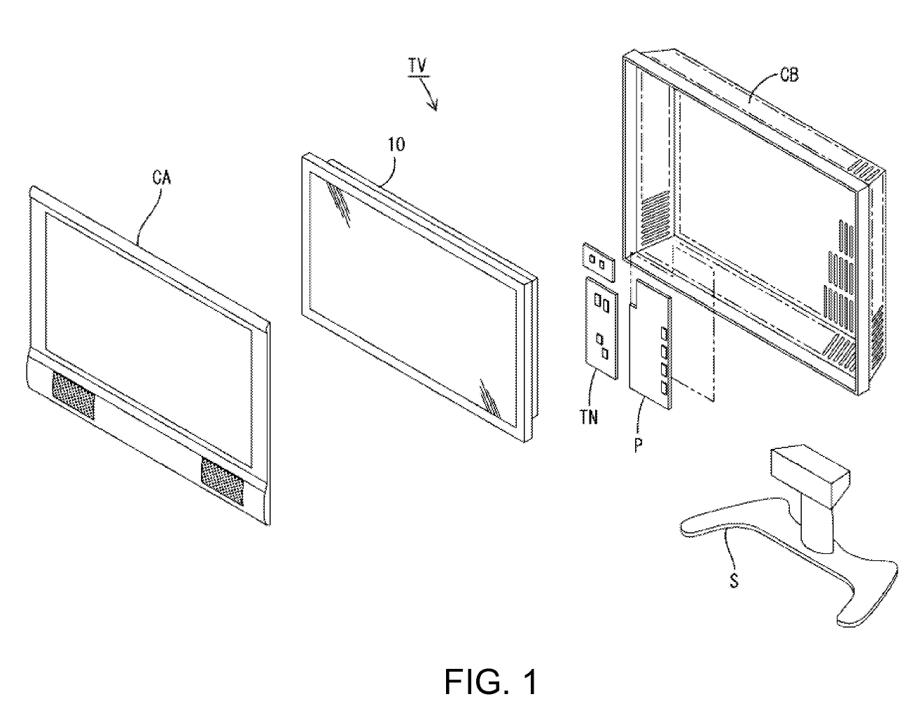

Embodiment 1 of the present invention is described with reference to FIGS. 1 through 7. In this embodiment, a television receiving apparatus TV equipped with a liquid crystal display apparatus 10 (display apparatus) is used as an example. The television receiving apparatus TV has, as shown in FIG. 1, the liquid crystal display apparatus 10, a cabinet composed of CA and CB that houses the liquid crystal display apparatus 10 in such a manner as to sandwich the liquid crystal display apparatus 10 from front and back, a power supply P, a tuner TN for receiving television broadcasting signals and the like, and a stand S. The liquid crystal display apparatus 10 is housed in the cabinet composed of CA and CB in an upright position with the display surface standing in a roughly vertical direction. Below, the constituting components are described assuming that the lower left side in FIG. 1 (the front side or the display side of the television receiving apparatus TV) is the front side, and the upper right side is the backside.

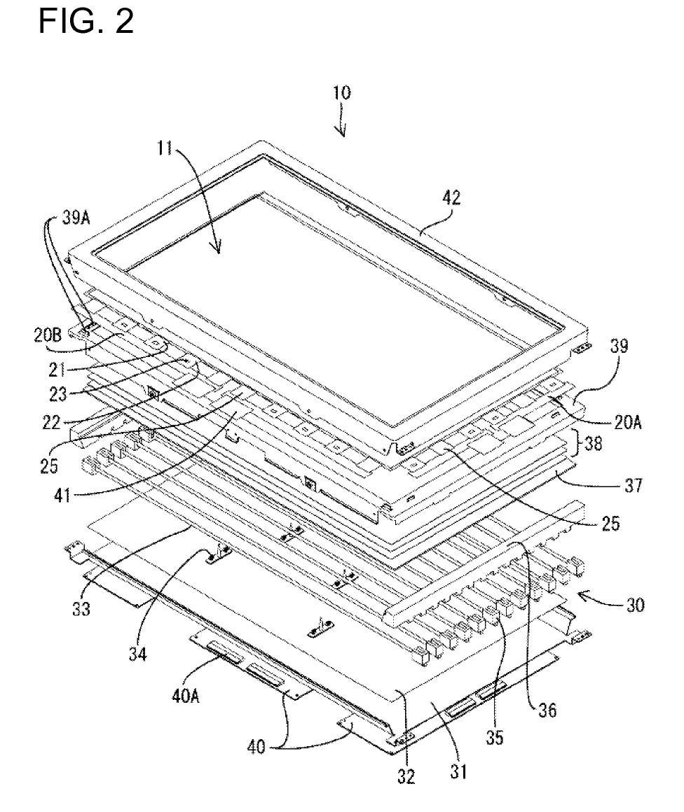

The liquid crystal display apparatus 10 has a horizontally long rectangular shape as a whole and, as shown in FIG. 2, has a liquid crystal panel 11 that is capable of displaying images (corresponding to the display panel of the present invention) and a backlight unit 30, an external light source that projects light towards the liquid crystal panel 11. These are held in a unified manner by a holding member such as a bezel 42.

The liquid crystal panel 11 has a pair of transparent (light transmissive) substrates 12 and 13, which are made of glass and have horizontally long rectangular shapes, and a liquid crystal layer 14 which is interposed between the substrates 12 and 13 and whose optical properties change according to the voltages applied.

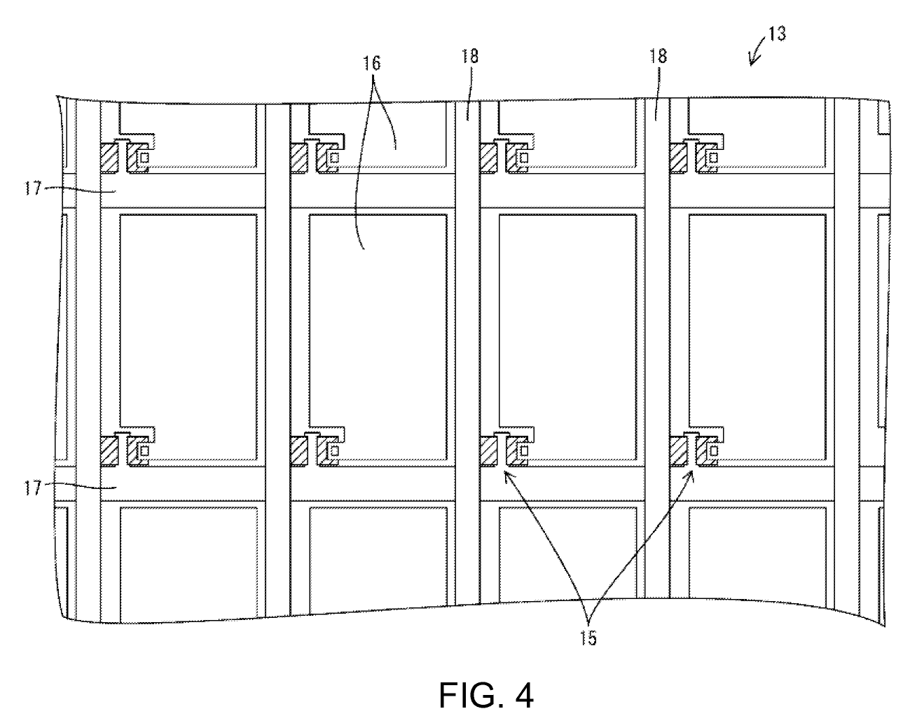

The substrates 12 and 13 are a CF substrate 12, which is on the front side, and an array substrate 13, which is on the backside, respectively. As shown in FIG. 4, on the inner surface of the array substrate 13 (the side facing the CF substrate 12), a large number of TFTs 15 (Thin Film Transistor), which are switching elements, and pixel electrodes 16 are arranged. Each of the pixel electrodes 16 is connected to the drain electrode of a TFT 15. TFT 15 and pixel electrode 16 are surrounded by gate wiring 17 and source wiring 18, which are disposed in a lattice structure. Gate wiring 17 is connected to the gate electrode of the TFT 15, and the source wiring 18 is connected to the source electrode of TFT 15.

On the array substrate 13, terminal sections (not shown) for wiring 17 and 18 are provided in the periphery of a display region (active area) where TFTs 15 and pixel electrodes 16 are disposed. The array substrate 13 is slightly larger than the CF substrate 12, and the terminal sections of wirings 17 and 18 are not overlapped by the CF substrate 12 and exposed to face the front side.

On the CF substrate 12, an opposite electrode (not shown) is provided to face the pixel electrodes 16 on the array substrate 13, and a large number of color filters (not shown) are arranged at locations corresponding to the respective pixels. The color filters are so arranged that three colors R, G, and B are laid out alternately. A pair of polarizing plates 19, which are facing each other with one disposed on the front side and the other on the backside, are bonded to the outer surfaces of the substrates 12 and 13, respectively.

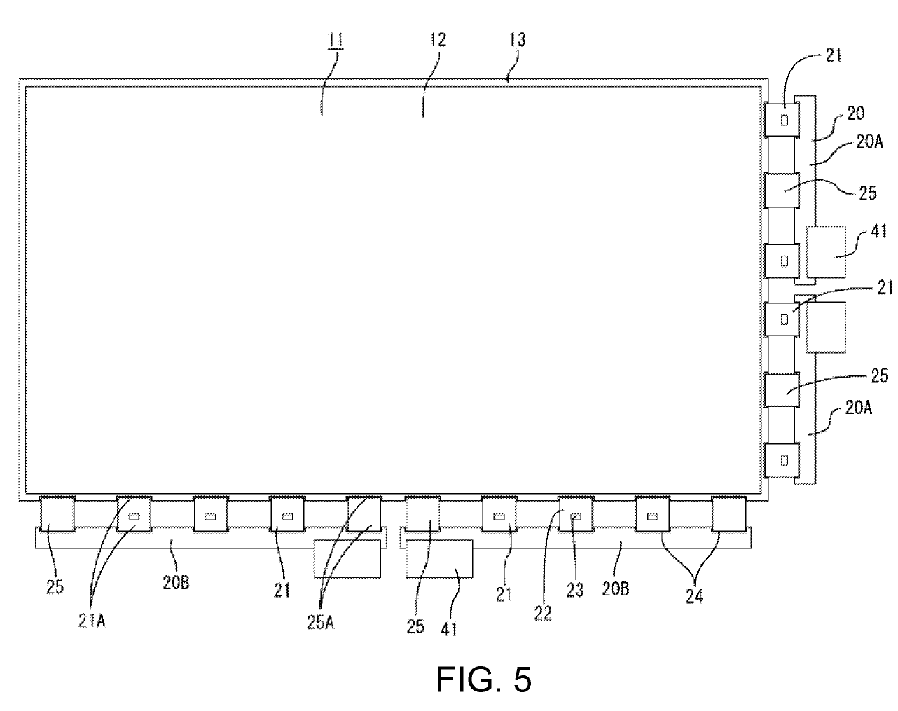

Along the periphery of the liquid crystal panel 11, driver substrates 20 (corresponding to the control substrates of the present invention) that send drive signals for driving the liquid crystal panel 11 are disposed (see FIG. 5). The driver substrates 20 are long and thin rectangular plates made of a synthetic resin, disposed along the periphery of the liquid crystal panel 11, having electrical components (not shown) such as capacitors and resistors mounted and electrically-conducting paths (not shown) printed thereon.

The driver substrates 20 are disposed along the shorter side and along the longer side of the periphery of the liquid crystal panel 11. Among the driver substrates 20, those disposed along the shorter side of the periphery of the liquid crystal panel 11 are referred to as gate driver substrates 20A, and those disposed along the longer side of the periphery of the liquid crystal panel 11 are referred to as source driver substrates 20B. The gate driver substrates 20A are connected to terminal sections of gate wirings 17, which are described later, through flexible substrates 21 and supply gate signals for driving the liquid crystal panel 11 to the liquid crystal panel 11. Source driver substrates 20B are connected to terminal sections of source wirings 18, which is described later, through flexible substrates 21, and supply source signals for driving the liquid crystal panel 11 to the liquid crystal panel 11.

There provided are two gate driver substrates 20A and two source driver substrates 20B. The longer side of the gate driver substrate 20A is about a half the length of the shorter side of the liquid crystal panel 11, and the longer side of the source driver substrate 20B is about a half the length of the longer side of the liquid crystal panel 11.

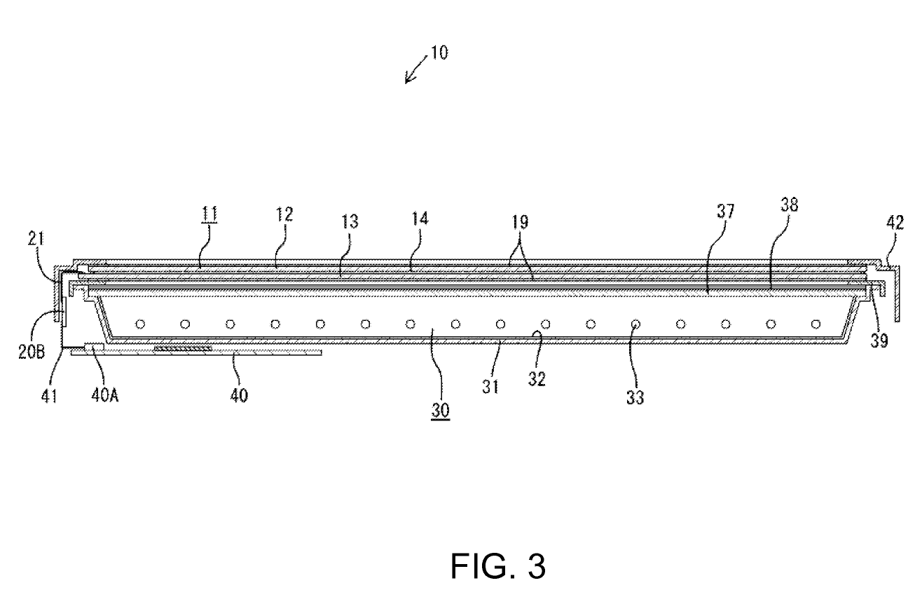

Driver substrates 20 are provided outside and away from the liquid crystal panel 11, with the plate surface extending perpendicularly to the plate surface of the liquid crystal panel 11 (see FIG. 3). The driver substrates 20 are electrically connected to various circuit substrates 40 attached to the backside of a chassis 31 through flexible printed substrates 41. The printed substrates 41 send control signals supplied from the circuit substrates 40 to the driver substrates 20.

The driver substrates 20A and 20B are electrically and mechanically connected to the liquid crystal panel 11 through a plurality of flexible substrates 21, and are mechanically connected to the liquid crystal panel 11 by reinforcing films 25 (corresponding to reinforcing members of the present invention) (see FIG. 5). The reinforcing film 25 will be described in detail later.

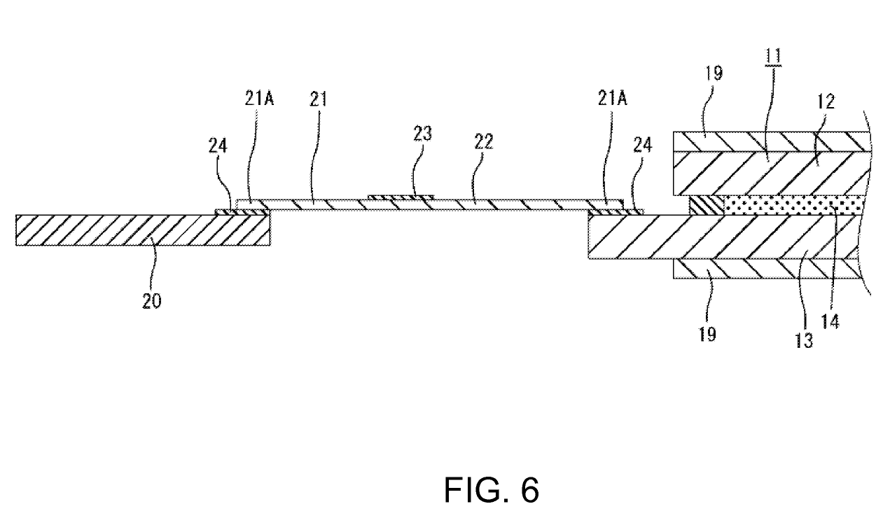

Flexible substrate 21 is a flexible, thin film, which is composed of a film 22 having electrically-conducting paths (not shown) printed and a driver 23 (corresponding to the electronic component of the present invention) such as an LSI chip mounted thereon (see FIG. 5 and FIG. 6). TCP (Tape Carrier Package), COF (Chip On Film), or SOF (System On Film), for example, is used as a flexible substrate 21. Film 22 of the flexible substrate 21 has a rectangular shape, and the driver 23 is mounted to approximately the center of the film 22 on either the front or back side.

The flexible substrate 21 is connected to an array substrate 13 of the liquid crystal panel 11 on one end, and is connected to the driver substrate 20 on the other end. Portions of the flexible substrate 21 that are connected to the liquid crystal panel 11 and the driver substrate 20, respectively (the portions pressed by a head, which is described later), are referred to as connecting portions 21A.

The connecting portions 21A of the flexible substrate 21 are bonded to a terminal section (not shown) of the array substrate 13 and to a terminal section of the driver substrate 20 through anisotropic conductive films 24 (ACF: Anisotropic Conductive Film). The anisotropic conductive film 24 is a film formed of a resin in which conductive metal particles are dispersed. The anisotropic conductive film 24 has a long and narrow rectangular shape to match with the connecting portion 21A of each of the flexible substrates 21. Each of the flexible substrates 21 is electrically and mechanically bonded to the liquid crystal panel 11 and to the driver substrate 20 through the anisotropic conductive films 24. Drive signals sent from the driver substrates 20A and 20B are supplied to wirings 17 and 18 of the liquid crystal panel 11 through the flexible substrates 21.

The flexible substrates 21 are disposed in the middle area of the longer side of each of the source driver substrates 20B (along the periphery of the liquid crystal panel 11), and on both ends of the longer side of each of the gate driver substrates 20A. All flexible substrates 21 are bent around the array substrate 13 of the liquid crystal panel 11 roughly perpendicularly, towards the back side (see FIG. 3).

A backlight unit 30 is a so-called direct lighting type backlight unit, and is disposed right below the backside of the liquid crystal panel 11. The backlight unit 30 includes a chassis 31 having a shape of a shallow dish concaving towards the back side. The chassis 31 is made of a metal, and a reflective sheet 32 is provided at the bottom surface. The reflective sheet 32 is made of a synthetic resin, and its surface color is white, a color that is highly light reflective.

A light source (cold-cathode tubes 33 in this embodiment) is provided in the chassis 31. The cold-cathode tubes 33 are provided in plurality, and arranged in parallel with each other. Each of the cold-cathode tubes 33 is supported at the middle of the axial direction, by lamp clips 34 provided on the surface of the reflective sheet 32 (see FIG. 2). Each of the both ends of the cold-cathode tube 33 is connected to a connector 35, and the ends of all the cold-cathode tubes 33 and the connectors 35 are covered by holders 36 in their entirety. The connectors 35 are electrically connected to a circuit substrate 40 provided at the back side of the chassis 31.

As shown in FIG. 2 and FIG. 3, a diffusion plate 37 and an optical sheet 38 are provided on the front side of the chassis 31. The diffusion plate 37 is a plate-shaped member made of synthetic resin in which light scattering particles are dispersed. The diffusion plate 37 scatters linear light projected by the cold-cathode tube 33, which is a linear light source. The diffusion plate 37 is rectangular-shaped, and has the longer sides along the axial direction of the cold-cathode tube 33. Both ends of the longer direction of the diffusion plate 37 rest on the holders 36, and both ends of the shorter direction of the diffusion plate 37 rest on the edges of the chassis 31.

Optical sheet 38 is provided on the front side of the diffusion plate 37. In this embodiment, the optical sheet 38 is a layer of, from the side close to the diffusion plate 37, a diffusion sheet, a lens sheet, and a reflective type polarizing plate 19. The optical sheet 38 converts the light from the cold-cathode tubes 33 that have passed through the diffusion plate 37 into planar light.

There is a frame 39, a frame-shaped metal component, provided on the front side of the periphery of the optical sheet 38 (see FIG. 2). The diffusion plate 37 and the optical sheet 38 are held in the backlight unit 30 with their peripheries sandwiched between the frame 39 and holders 36, or between the frame 39 and chassis 31.

On the frame 39, panel support sections 39A that support the periphery of the liquid crystal panel 11 are provided. The panel support sections 39A are formed by lifting partially cut-out portions of the frame 39 towards the front side, and the lifted portions are in an upright position facing the periphery of the liquid crystal panel 11. There is a bezel 42, a frame-shaped metal component, provided on the front side of the liquid crystal panel 11, and the liquid crystal panel 11 is held in there with its periphery sandwiched between the bezel 42 and the frame 39.

On the backside of the chassis 31, various circuit substrates 40 that control the driving of the cold-cathode tubes 33 are attached (see FIG. 2). The circuit substrates 40 are disposed on both ends and at the middle of the longer side of the chassis 31. Connectors 40A are mounted on the surface of each of the circuit substrates 40, and printed substrates 41 are electrically connected to the connectors 40A (see FIG. 3).

A reinforcing film 25 is a flexible thin film, and is identical to the film 22 of the flexible substrate 21 (i.e., this is the film 22 for the flexible substrate 21 on which the driver 23 is not mounted). The reinforcing film 25 is rectangular, has the same shape and size as the film 22 of the flexible substrate 21, and also has the same thickness as the film 22 of the flexible substrate 21 (see FIG. 5).

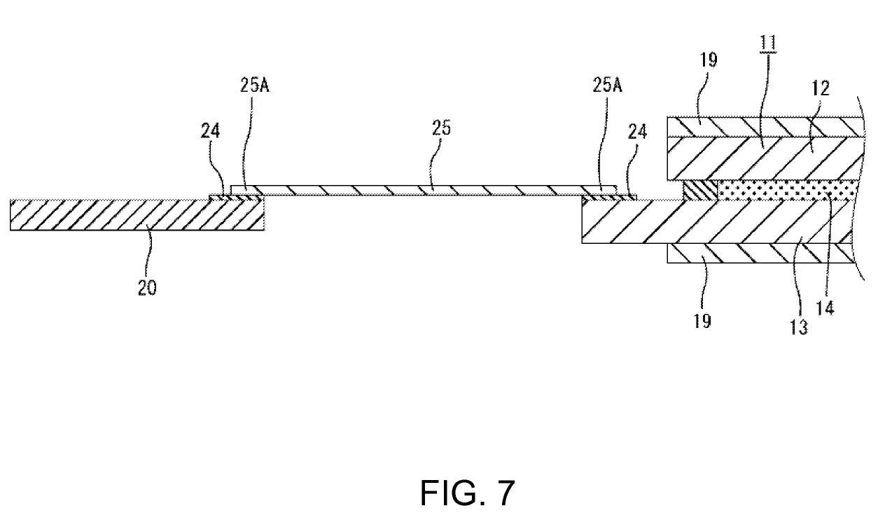

One end of the reinforcing film 25 is connected to the array substrate 13 of the liquid crystal panel 11, and the other end is connected to the driver substrate 20 (see FIG. 7). Portions of the reinforcing film 25 that are connected to the liquid crystal panel 11 and to the driver substrate 20 (the portions pressed by a head, which is described later) are respectively referred to as connecting portions 25A.

The connecting portions 25A of the reinforcing film 25 are bonded to the terminal section of the array substrate 13 and to the terminal section of each of the driver substrate 20, respectively, through anisotropic conductive films 24. The anisotropic conductive film 24 used for connecting the reinforcing film 25 and the anisotropic conductive film 24 used for connecting the flexible substrate 21 have about the same shape and size, and are of the same kind. Each of the reinforcing films 25 is mechanically bonded to the liquid crystal panel 11 and the driver substrate 20 through the anisotropic conductive films 24.

The reinforcing films 25 are disposed on both ends of the longer side of each of the source driver substrate 20B (along the periphery of the liquid crystal panel 11), and in the middle area of the longer side of each of the gate driver substrates 20A (see FIG. 5). The flexible substrates 21 and the reinforcing films 25 are arranged at a predetermined pitch along the edge of each of the driver substrates 20. Similar to the flexible substrates 21, the reinforcing films 25 are bent around the array substrate 13 of the liquid crystal panel 11 roughly perpendicularly towards the back side.

Next, bonding process of the flexible substrate 21 and the reinforcing film 25 is described below.

As step one, the flexible substrates 21 and the reinforcing films 25 are bonded to the periphery of the liquid crystal panel 11. First, uncured anisotropic conductive films 24 are applied to the connecting sites in the periphery of the liquid crystal panel 11 for the flexible substrates 21 and for the reinforcing films 25. More specifically, the anisotropic conductive films 24 are applied on the periphery of the liquid crystal panel 11 along one shorter side and along one longer side at a predetermined pitch.

Subsequently, the flexible substrates 21 and the reinforcing films 25 are arranged along the periphery of the liquid crystal panel 11. More specifically, connecting portions 21A of the flexible substrates 21 and connecting portions 25A of the reinforcing films 25 are positioned so that they are aligned over the front side of respective ones of the anisotropic conductive films 24. Next, once the connecting portions 21A of the flexible substrates 21 and the connecting portions 25A of the reinforcing films 25 are arranged on the front side of the liquid crystal panel 11 with the anisotropic conductive films 24 sandwiched in between, the connecting portions 21A of the flexible substrates 21 and the connecting portions 25A of the reinforcing films 25 are pressed against the liquid crystal panel 11 by a heated head (not shown). The head is long and extends along the periphery of the liquid crystal panel 11, and is designed to press a plurality of connecting portions 21A and 25A simultaneously. When the anisotropic conductive films 24 are heat pressed for a predetermined period of time under a predetermined load, the anisotropic conductive films 24 are cured and the liquid crystal panel 11 and the flexible substrates 21 are electrically and mechanically connected together, and the liquid crystal panel 11 and the reinforcing films 25 are mechanically connected together.

Next, the flexible substrates 21 and the reinforcing films 25 are bonded to the driver substrates 20. First, similar to the bonding to the liquid crystal panel 11, uncured anisotropic conductive films 24 are applied on the predetermined locations of the driver substrates 20, and the flexible substrates 21 and the reinforcing films 25 are placed over the front side of the anisotropic conductive films 24. Then, the connecting portions 21A of the flexible substrates 21 and the connecting portions 25A of the reinforcing films 25 are heat pressed simultaneously. As a result, the flexible substrates 21 are electrically and mechanically connected to the driver substrates 20, and the reinforcing films 25 are mechanically connected to the driver substrates 20. This completes the bonding process of the flexible substrates 21 and the reinforcing films 25.

Next, the mechanism and effect of Embodiment 1 configured as above are described below.

Embodiment 1 provides a display apparatus having a liquid crystal panel 11, driver substrates 20, which are disposed along the periphery of the liquid crystal panel 11 and control the display of the liquid crystal panel 11, flexible substrates 21, which electrically and mechanically connect the liquid crystal panel 11 and the driver substrates 20 together, and reinforcing films 25, which mechanically connect the liquid crystal panel 11 and the driver substrates 20 together. The thickness of connecting portions 25A of the reinforcing film 25 is set to be equal to or smaller than the thickness of connecting portions 21A of the flexible substrate 21, and connecting portions 21A of the flexible substrates 21 and connecting portions 25A of reinforcing films 25 are bonded to the liquid crystal panel 11 and to the driver substrates 20 by anisotropic conductive films 24.

In this configuration, the liquid crystal panel 11 and the driver substrates 20 are mechanically connected together not only by the flexible substrates 21 but also by the reinforcing films 25. That is, the force from vibration of the driver substrate 20 or the like is received not only by the flexible substrates 21 but also by the reinforcing films 25. As a result, compared to the case where the liquid crystal panel and the driver substrates are connected together only by the flexible substrates, the stress placed on the flexible substrates 21 can be reduced, thereby preventing deterioration of the display quality. Also, since the flexible substrates 21 and the reinforcing films 25 can be bonded to the liquid crystal panel 11 and to the driver substrates 20 simultaneously, bonding process can be simplified compared to the case where these components are bonded separately.

Furthermore, the reinforcing films 25 are bonded to the liquid crystal panel 11 and the driver substrate 20 with the anisotropic conductive films 24. This ensures more reliable bonding to the liquid crystal panel 11 and to the driver substrate 20, compared to the case where these components are bonded with double-sided tapes or the like.

The flexible substrate 21 is composed of a film 22 with a driver 23 mounted thereon, and the reinforcing film 25 is composed of the film 22 for the flexible substrate 21 alone. This ensures that the thickness of the connecting portions 25A of the reinforcing film 25 is equal to the thickness of the connecting portions 21A of the flexible substrate 21. If the reinforcing film is made of a material other than the film 22 for the flexible substrate 21, careful attention is required when setting the thickness of the connecting portion of the reinforcing film for the following reason. That is, if the connecting portions of the reinforcing film are thicker than the connecting portion 21A of the flexible substrate 21 even slightly, when the connecting portions of the reinforcing film and the connecting portions 21A of the flexible substrate 21 are bonded simultaneously, the connecting portion 21A of the flexible substrate 21 cannot receive a sufficient pressure from the head, which could cause a problem such as an insufficient connection. However, as in the case of this embodiment, if the reinforcing film 25 is composed of the film 22 for the flexible substrate 21 alone, the thickness of the connecting portion 25A of the reinforcing film 25 is surely equal to the thickness of the connecting portions 21A of the flexible substrate 21, and such a problem can be prevented without requiring any special attention in setting the thickness of the connecting portions 25A of the reinforcing film 25.

Here, defective flexible substrates 21, i.e. those without the driver 23 because the driver 23 have failed to be mounted during the manufacturing process or because the driver 23 was detached after the manufacturing process, can also be used as the reinforcing films 25. In such a case, resources can be used efficiently.

On a source driver substrate 20B, reinforcing films 25 are connected to the both ends of the longer side. The ends of the longer side of the source driver substrate 20B are the places which are most significantly subjected to stresses such as vibration of the source driver substrate 20B. The reinforcing films 25 disposed on such high-stress locations, therefore, can reduce the stress placed on the flexible substrate 21 efficiently.

### Embodiment 2

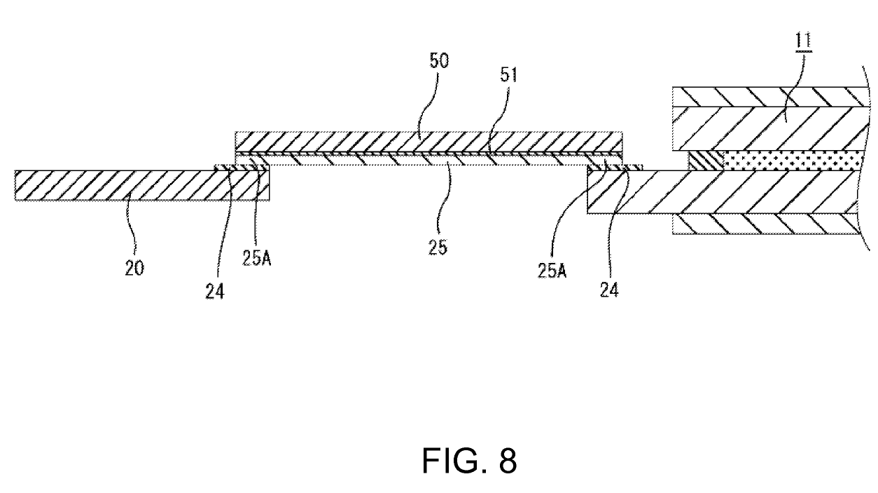

Next, a television receiving apparatus TV according to Embodiment 2 of the present invention is described with reference to FIG. 8.

A television receiving apparatus TV according to this embodiment is different from Embodiment 1 in that a strengthening film 50 (corresponding to the strengthening member of the present invention) is attached to the reinforcing film 25. Here, same reference characters are used for components similar to those of Embodiment 1, and redundant descriptions are omitted.

As in Embodiment 1, the liquid crystal display apparatus 10 of a television receiving apparatus TV according to this embodiment has a liquid crystal panel 11 that is capable of displaying images and a backlight unit 30 that projects light towards the liquid crystal panel 11, and they are held in a unified manner by a holding member such as a bezel 42.

Likewise, driver substrates 20 are disposed along the periphery of the liquid crystal panel 11. Each of the driver substrates 20 is electrically and mechanically connected to the liquid crystal panel 11 by the flexible substrates 21, and is mechanically connected to the liquid crystal panel 11 by the reinforcing films 25.

A strengthening film 50 is attached to the reinforcing film 25. The strengthening film 50 is a resin film (it is a polyimide film in this embodiment), which is sheet-shaped and thicker than the reinforcing film 25. The planar shape of the strengthening film 50 is about the same as that of the reinforcing film 25, and one strengthening film 50 is provided for each reinforcing film 25. The strengthening film 50 is provided on the entire side of one of the front and back sides of the reinforcing film 25 (on the side opposite the side that is bonded to the liquid crystal panel 11 and the driver substrate 20). The strengthening film 50 is bonded to the reinforcing film 25 through a double-sided tape 51. The strengthening film 50 is bonded to each of the reinforcing films 25 after the flexible substrates 21 and the reinforcing films 25 are bonded to the liquid crystal panel 11 and the driver substrates 20. The strengthening film 50 is bonded to all the reinforcing films 25.

Embodiment 2 configured as described above provides the following effects. As in Embodiment 1, the liquid crystal panel 11 and the driver substrates 20 are mechanically connected together not only by the flexible substrates 21 but also by the reinforcing films 25. As a result, stress placed on the flexible substrates 21 can be reduced, thereby preventing deterioration of the display quality. Also, as in Embodiment 1, the flexible substrates 21 and the reinforcing films 25 can be bonded simultaneously, which makes the bonding process simpler compared to the case where these components are bonded separately.

Furthermore, since the strengthening film 50 is attached to the reinforcing film 25, the rigidity of the reinforcing film 25 is improved compared to the case where the reinforcing film 25 alone is used. As a result, reinforcing film 25 can handle more stress caused by vibrations of driver substrate 20 or the like, thereby reducing the stress placed on the flexible substrate 21.

The strengthening film 50 is sheet-shaped and its thickness is greater than that of the reinforcing film 25. The extra thickness of the strengthening film 50 significantly improves the rigidity of the reinforcing film 25, which further reduces the stress placed on the flexible substrate 21.

Also, the strengthening film 50 is bonded to the entirety of one of the front and back sides of the reinforcing film 25. Compared to the case where a strengthening member is bonded only partially, this structure further improves the entire rigidity of the reinforcing film 25.

### Embodiment 3

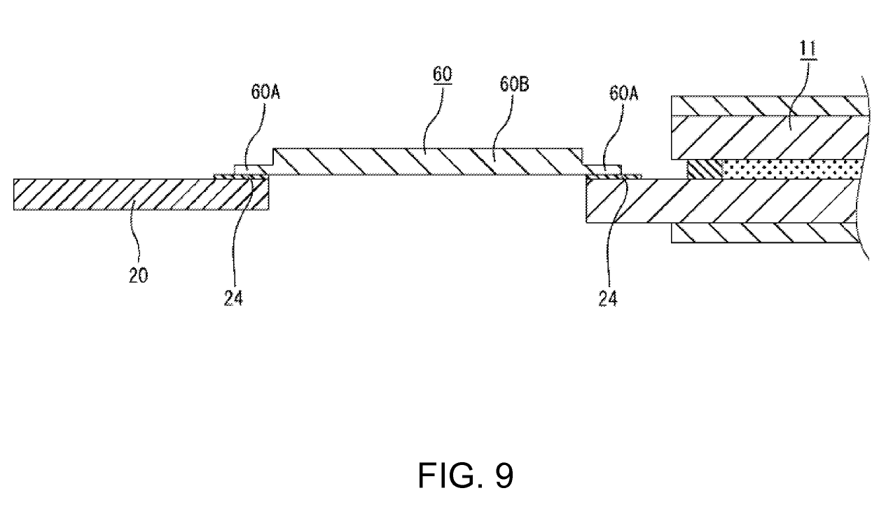

Next, a television receiving apparatus TV according to Embodiment 3 of the present invention is described below with reference to FIG. 9.

A television receiving apparatus TV according to this embodiment is different from a television receiving apparatus TV of Embodiment 1 in that the portion of a reinforcing film 60 that is not connecting portions 60A is thicker than the connecting portions 60A. Here, same reference characters are used for the components similar to those in Embodiment 1 and redundant descriptions are omitted.

As in Embodiment 1, the liquid crystal display apparatus 10 of a television receiving apparatus TV according to this embodiment has a liquid crystal panel 11 that is capable of displaying images and a backlight unit 30 that projects light towards liquid crystal panel 11, and they are held in a unified manner by a holding member such as a bezel 42.

Driver substrates 20 are disposed around the liquid crystal panel 11. Each of the driver substrates 20 is electrically and mechanically connected to the liquid crystal panel 11 through flexible substrates 21, and is mechanically connected to the liquid crystal panel 11 through reinforcing films 60.

The reinforcing film 60 is a resin film (it is a polyimide film in this embodiment). The planar shape and the size of the reinforcing film 60 as a whole are about the same as that of the flexible substrate 21. The thickness of the connecting portions 60A of the reinforcing film 60 (i.e. both ends of the reinforcing film 60) are set to be equal to the thickness of the film 22 of the flexible substrate 21. As in Embodiment 1, the connecting portions 60A of the reinforcing film 60 are bonded to the liquid crystal panel 11 and to the driver substrate 20, respectively, through anisotropic conductive films 24.

The thickness of the portion of the reinforcing film 60 that is not the connecting portion 60A (referred to as main portion 60B) is greater (at least twice greater) than that of the connecting portions 60A. The thickness of the main portion 60B of the reinforcing film 60 is substantially constant throughout its entirety. The reinforcing film 60 has a stepped structure with a step dividing the main portion 60B from the connecting portions 60A.

Embodiment 3 configured as described above provides the following effects.

As in Embodiment 1, the liquid crystal panel 11 and the driver substrates 20 are mechanically connected together, not only by the flexible substrates 21, but also by the reinforcing films 60. As a result, stress placed on the flexible substrate 21 can be reduced, thereby preventing the deterioration of the display quality. Also, as in Embodiment 1, the flexible substrates 21 and the reinforcing films 60 can be bonded simultaneously, which makes the bonding process simpler compared with the case where these components are bonded separately.

Furthermore, the thickness of the main portion 60B of the reinforcing film 60 is greater than that of the connecting portion 60A. That is, besides being able to be bonded together with the flexible substrate 21, the reinforcing film 60 achieves a high overall rigidity. Also, compared with the case where a strengthening member is attached to provide a higher rigidity after the reinforcing film is bonded, the bonding process of this embodiment is simpler, because a separate step of attaching a strengthening member is eliminated.

### Other Embodiments

The present invention is not limited to the embodiments described above with reference to figures. The following embodiments, for example, also fall within the technical scope of the present invention.

(1) In the embodiments described above, driver substrates 20 are disposed along one shorter side and one longer side of the periphery of the liquid crystal panel 11. However, the present invention is not limited to such configuration, and the driver substrate can be disposed at any other location of the periphery of the liquid crystal panel. For example, the driver substrates may be disposed along the entire periphery of the liquid crystal panel.

(2) In the embodiments described above, the flexible substrates 21 are disposed in the middle area and the reinforcing films 25(60) are disposed at both ends of the source driver substrate 20B; and the flexible substrates 21 are disposed on both ends and the reinforcing films 25(60) are disposed in the middle area of the gate driver substrate 20A. The present invention, however, is not limited to this configuration. Flexible substrates and reinforcing films may be disposed at any locations along the longer side of each of the driver substrates.

(3) In the embodiments described above, uncured anisotropic conductive films 24 are applied to the liquid crystal panel 11 and the driver substrates 20 first, and then flexible substrates 21 and reinforcing films 25(60) are pressure bonded to them. However, the present invention is not limited to such procedure. Uncured anisotropic conductive films may be applied to flexible substrates or reinforcing films first, and then the flexible substrates or the reinforcing films may be pressure bonded to the liquid crystal panel or the driver substrate.

(4) In the embodiments described above, the flexible substrates 21 and reinforcing films 25(60) are pressure bonded to the liquid crystal panel 11 first, and then pressure bonded to the driver substrates 20. The present invention, however, is not limited to such procedure. For example, flexible substrates and reinforcing films may be pressure bonded to driver substrates first, and then pressure bonded to the liquid crystal panel. Alternatively, flexible substrates and reinforcing films may be pressure bonded to the liquid crystal panel and the driver substrates simultaneously.

(5) In the embodiments described above, each of the anisotropic conductive films 24 has a long narrow rectangular shape that matches the connecting portion 21A of each of the flexible substrates 21 and the connecting portion 25A(60A) of each of the reinforcing film 25(60) and is applied at the connecting sites of the flexible substrate 21 and the connecting sites of the reinforcing film 25(60). However, the anisotropic conductive film can be of any shape as long as it can accommodate simultaneous bonding of the flexible substrates 21 and the reinforcing films 25. For example, an anisotropic conductive film may have a long and narrow shape so that it extend over a plurality of connecting sites of the flexible substrates and the reinforcing films.

(6) In Embodiment 2, the strengthening film 50 is attached to one of the front and back sides of the reinforcing film 25. However, the present invention is not limited to this. The strengthening film may be attached to the other one of the front and back sides of the reinforcing film, or may be attached to both front and back sides of the reinforcing film.

(7) In Embodiment 2, the strengthening film 50 is attached to the reinforcing film 25 through a double-sided tape 51. However, the present invention is not limited to such. A strengthening film may be attached to the reinforcing film by any means.

(8) In Embodiment 2, the strengthening member is the strengthening film 50 whose planar shape as a whole and the size are about the same as those of the flexible substrate 21. However, the present invention is not limited to such. The strengthening member may take any form. For example, the strengthening member may have a stick-like shape so that several of them are arranged in parallel and are attached to the reinforcing member.

(9) In Embodiment 3, the reinforcing film 60 has greater rigidity because it has a main portion 60B that is thicker than the connecting portions 60A. However, a strengthening member may also be attached to this reinforcing film.

1. A display apparatus comprising a display panel, control substrates disposed along a periphery of said display panel to control display of said display panel, flexible substrates interposed between said display panel and said control substrates to electrically and mechanically connect them together, and reinforcing members interposed between said display panel and said control substrate to reinforce mechanical connection between them,
wherein a thickness of connecting portions of said reinforcing member, which are for connection to said display panel and to said control substrate, is equal to or smaller than a thickness of connecting portions of said flexible substrate, which are for connection to said display panel and to said control substrate, and
wherein the connecting portions of said flexible substrate and the connecting portions of said reinforcing member are bonded to said display panel and to said control substrate by anisotropic conductive films.

2. The display apparatus according to claim 1, wherein said flexible substrate is composed of a film with an electronic component mounted thereon, and said reinforcing member is composed only of the film for said flexible substrate.

3. The display apparatus according to claim 1, wherein a strengthening member is attached to said reinforcing member.

4. The display apparatus according to claim 3, wherein said strengthening member is attached to at least one of front and back sides of said reinforcing member.

5. The display apparatus according to claim 3, wherein said strengthening member is sheet-shaped.

6. The display apparatus according to claim 5, wherein a thickness of said strengthening member is greater than a thickness of said reinforcing member.

7. The display apparatus according to claim 5, wherein said strengthening member is bonded to an entirety of the at least one of the front and back sides of said reinforcing member.

8. The display apparatus according to claim 5, wherein said strengthening member is a polyimide film.

9. The display apparatus according to claim 1, wherein a portion of said reinforcing member that is not connecting portions for connection to said display panel and to said control substrate has a thickness greater than the thickness of said connecting portions.

10. The display apparatus according to claim 1, wherein said reinforcing members are connected at end portions of a longer side of said control substrate.

11. The display apparatus according to claim 1, wherein said display panel is a liquid crystal panel using liquid crystal.

12. A television receiving apparatus comprising the display apparatus according to claim 1.
